(19) United States
(12) Patent Application Publication
(10) Pub. No.: US 2005/0081553 A1
(43) Pub. Date: Apr. 21, 2005

(54) Device for manually manufacturing ice cream

(76) Inventor: Jen Yen Yen, Chang Hua Hsien (TW)

Correspondence Address: JEN YEN YEN, 235 CHUNG-HO BOX 8-24, TAIPEI HSIEN, 235, TW

(21) Appl. No.: 10/687,898

(22) Filed: Oct. 17, 2003

(51) Int. Cl. F25C 1/00; A23G 9/00; F25D 3/08

(52) U.S. Cl. 62/340; 62/345; 62/457.2

(57) ABSTRACT

A device for manually manufacturing ice cream comprises a machine table with a rotary bush at one end. A handle is protruded from the rotary bush. A rotary cylinder is supported in the machine table and driven by the handle. The rotary cylinder includes an outer cylinder, a polygonal inner cylinder in the outer cylinder, and a metal rolling cylinder within the inner cylinder. Ice blocks are placed within the polygonal inner cylinder and surrounds the metal rolling cylinder. Liquid to be made into ice cream is placed in the metal rolling cylinder. A temperature isolating layer is installed between the outer cylinder and the inner cylinder. By rotating the handle manually, the polygonal inner cylinder, -outer cylinder and metal rolling cylinder will rotate and thus, the heat of the liquid in the metal rolling cylinder will be transferred to the ice block so as to form ice cream.

### FIELD OF THE INVENTION

The present invention relates to ice cream manufacturing devices, and particularly to a device for manually manufacturing ice cream.

### BACKGROUND OF THE INVENTION

In the prior art ice cream manufacturing device, a machine table is installed with a cylinder and an agitator therein. Liquid within the cylinder is temperature-reduced as ice and then the agitator stirs the ice as ice cream. However, this prior art has the following disadvantages. The device has a larger volume and thus it is not suitable to be used at home. Refrigerant and compressors are necessary and longer time is necessary for getting the ice cream. A large amount of ice creams are acquired at one time and thus it is not suitable to be used at home.

### SUMMARY OF THE INVENTION

Accordingly, the primary object of the present invention is to provide a device for manually manufacturing ice cream which comprises a machine table with a rotary bush at one end. A handle is protruded from the rotary bush. A rotary cylinder is supported in the machine table and driven by the handle. The rotary cylinder includes an outer cylinder, an polygonal inner cylinder in the outer cylinder, and a metal rolling cylinder within the inner cylinder. Ice blocks are placed within the polygonal inner cylinder and surrounds the metal rolling cylinder. Liquid to be made into ice cream is placed in the metal rolling cylinder. A temperature isolating layer is installed between the outer cylinder and the inner cylinder. By rotating the handle manually, the polygonal inner cylinder, outer cylinder and metal rolling cylinder will rotate and thus, the heat of the liquid in the metal rolling cylinder will be transferred to the ice block so as to form ice cream.

The various objects and advantages of the present invention will be more readily understood from the following detailed description when read in conjunction with the appended drawing.

### BRIEF DESCRIPTION OF THE DRAWINGS

FIG. 1 shows a perspective view of the present invention.

FIG. 2 shows an exploded perspective view of the present invention.

FIG. 3 is a front cross sectional view of the present invention.

FIG. 4 is an assembled cross sectional view and operation lateral view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

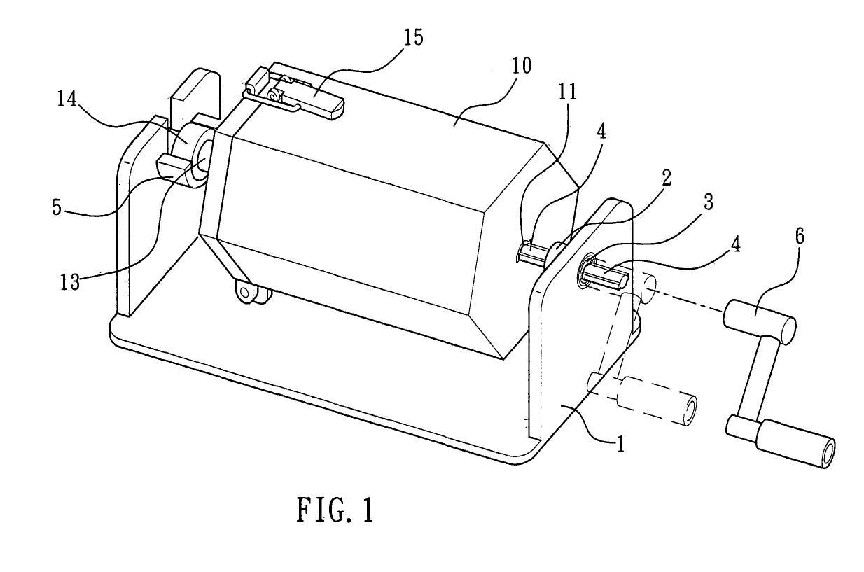

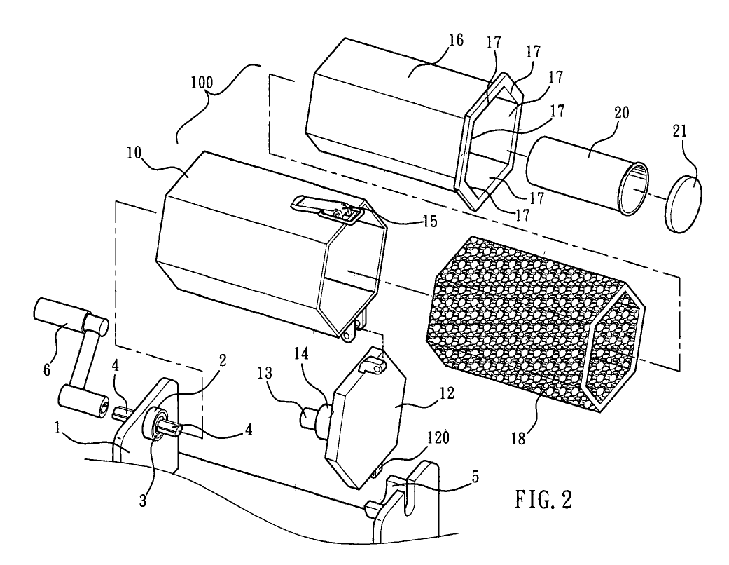

With reference to FIGS. 1, 2, 3, and 4, the present invention comprises a machine table 1 with a rotary bush 2 at one end. A bearing 3 and a driving shaft 4 protrudes from the rotary bush 2. An outer end of the driving shaft 4 out of the rotary bush 2 is installed with a rotary handle 6. Another end of the machine table 1 is installed with a shaft seat 5. A detachable rotary cylinder 100 is installed between the driving shaft 4 and the shaft seat 5. A metal rolling cylinder 20 is installed within the rotary cylinder 100.

The rotary cylinder 100 is formed by an outer cylinder 10, an polygonal inner cylinder 16, a temperature isolating layer 18, and a cylinder cover 12.

The temperature isolating layer 18 is installed between and firmly secured to the outer cylinder 10 and the inner cylinder 16.

One end of the polygonal outer cylinder 10 has a connecting groove 11 which can be inserted into the driving shaft 4 of the machine table so that the outer cylinder 10 rotates with the driving shaft 4. Another end of the polygonal outer cylinder 10 is installed with a buckle 15 for pivotally connecting to the cylinder cover 12.

One end of the cylinder cover 12 has a hook 120 for buckling with the buckle 15 of the outer cylinder 10. Thereby the cylinder cover 12 tightly seals the inner cylinder 16. An outer center of the cover 12 is formed with a supporting shaft 13. A bearing 14 is engaged to the supporting shaft 13. The supporting shaft 13 with the bearing 14 is embedded to the shaft seat 5 of the machine table 1. Thereby, the rotary cylinder 100 can rotate in equilibrium.

An inner wall 17 of the inner cylinder 16 also has a polygonal shape. Ice blocks 7 are filled into the polygonal inner cylinder 16 and around the metal rolling cylinder 20.

The metal rolling cylinder 20 is made of heat conductive metal and a telescopic tuber sealing cover 21 is used to seal an opening of the metal rolling cylinder. Liquid to be made as ice cream is filled within the metal rolling cylinder 20.

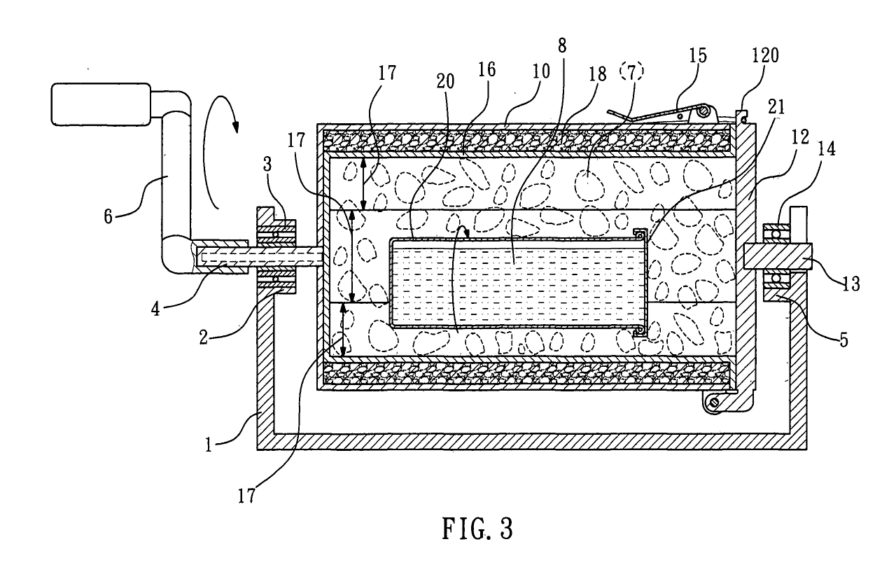

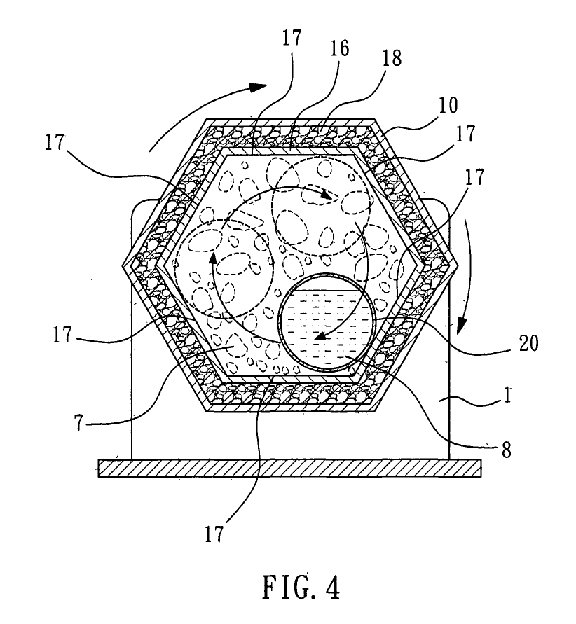

In the application of the present invention, the rotary cylinder 100 is detached from the machine table 1. Then ice blocks 7 are filled into the inner cylinder 16. The metal rolling cylinder 20 filled with liquid 8 (for example, juicy) is placed in the ice blocks 7. Then cylinder cover 12 is buckled so as to cover the inner cylinder. The connecting groove 11 of the polygonal outer cylinder 10 of the rotary cylinder 100 is inserted by the driving shaft 4 of the machine table 1. The supporting shaft 13 and bearing 14 of the cylinder cover 12 are embedded into the shaft seat 5. Then the handle 6 is rotated so as to rotate the driving shaft 4 at an outer end of the machine table 1. The rotary cylinder 100 can be driven to rotate, and the inner wall 17 of the polygonal inner cylinder 16, as shown in FIGS. 3 and 4, is moved to drive the ice blocks 7 and metal rolling cylinder 20. In other words, the inner wall 17 will turn the ice blocks 7 so that the metal rolling cylinder 20 also turns. The turning of the ice blocks 7 will cause liquid in the metal rolling cylinder 20 to be cooled. Due to the turning and rotation of the metal rolling cylinder 20, the liquid will not be cold as ice, but it is cooled into ice cream.

In the present invention, the ice cream can be got rapidly. The principle will be described here. The metal rolling cylinder 20 will transfer the heat of the water in the metal rolling cylinder 20 to the ice blocks and the movement of the ice blocks 7 and metal rolling cylinder 20 cause the liquid 8 to flow rapidly. Thereby, the temperature of the liquid 8 in the metal rolling cylinder 20 can be reduced greatly. Moreover, the temperature isolating layer 18 serves to retain the temperature of the ice blocks 7 so that all the ice blocks 7 is contributed to the reduction of the temperature of the liquid 8 in the metal rolling cylinder 20.

Moreover, the inner wall 17 of the polygonal inner cylinder 16 is a special design so that the ice blocks 7 and the metal rolling cylinder 20 can transfer the heat of liquid 8 in the metal rolling cylinder 20 to the outer ice blocks 7 by the rotation and turning of the ice blocks 7 and metal rolling cylinder 20.

Thereby, from above description, it is known that in the present invention, the ice cream can be got quickly. No refrigerant and compressor are necessary. Moreover, the different liquids, such as juicy, soda, milk can be placed within the metal rolling cylinder 20 so as to get the required ice cream.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A device for manually manufacturing ice cream comprising
a machine table with a rotary bush at one end; a bearing and a driving shaft protruding from the rotary bush; an outer end of the driving shaft out of the rotary bush being installed with a rotary handle; another end of the machine table being installed with a shaft seat; a detachable rotary cylinder being installed between the driving shaft and the shaft seat; a metal rolling cylinder being installed within the rotary cylinder,
the rotary cylinder comprising:
a polygonal outer cylinder; one end of the polygonal outer cylinder having a connecting groove capable of being inserted by the driving shaft of the machine table so that the outer cylinder rotates with the driving shaft; another end of the polygonal outer cylinder being installed with a buckle for pivotally connecting to the cylinder cover;
a polygonal inner cylinder within the outer cylinder; an inner wall of the inner cylinder also has a polygonal shape; ice blocks being filled into the polygonal inner cylinder;
a temperature isolating layer installed between and firmly secured to the outer cylinder and the inner cylinder;
a metal rolling cylinder within the polygonal inner cylinder and surrounded by the ice blocks; the metal rolling cylinder being made of heat conductive metal;
a telescopic tuber sealing cover being used to seal an opening of the metal rolling cylinder; liquid to be made as ice cream is filled within the metal rolling cylinder; and
a cylinder cover; one end of the cylinder cover having a hook for buckling with the buckle of the outer cylinder; thereby the cylinder cover tightly sealing the inner cylinder; an outer center of the cover being formed with a supporting shaft; a bearing being engaged to the supporting shaft; the supporting shaft with the bearing being embedded to the shaft seat of the machine table; thereby, the rotary cylinder rotating in equilibrium;
wherein by rotating the handle manually, the rotary cylinder rotates, and thus, the-polygonal inner cylinder, outer cylinder and metal rolling cylinder will rotate, the heat of the liquid in the metal rolling cylinder will be transferred to the ice block so as to form ice cream.
